(19) United States
(12) Patent Application Publication
(10) Pub. No.: US 2005/0242020 A1
(43) Pub. Date: Nov. 3, 2005

(54) Oil slick harvester

(76) Inventor: Clive Stephen Montague Fisk, Somerset (GB)

Correspondence Address: MELVIN I. STOLTZ, ESQ., 51 CHERRY STREET, MILFORD, CT, 06460, US

(21) Appl. No.: 10/519,966

(22) PCT Filed: Jul. 1, 2002
(86) PCT No.: PCT/GB02/03023

§ 371 Date: Jun. 17, 2005

(51) Int. Cl. C02F 1/38

(52) U.S. Cl. 210/359

(57) ABSTRACT

A method of harvesting an oil slick includes: a) providing an oil slick harvesting vessel (10) which has an endless belt conveyor (14) for conveying spilled oil from one side of the vessel (10) to the other and deployable hinged panels (11, 12 and 13) which extend along both ends and said other side of the vessel (10); b) deploying the hinged panels (11, 12 and 13) so that they encompass an area on said other side of the vessel (10) and within which the spilled oil can be collected, and c) operating the endless belt conveyor (14) to transfer the spilled oil into the encompassed area.

### FIELD OF THE INVENTION

This invention relates to methods and means for the harvesting of oil slicks.

In British Patent Specification No. 2 310 381 there is described an oil slick harvesting vessel which has a mid-mounted endless belt conveyor for conveying spilled oil from one side of the vessel to the other and deployable hinged end panels which can be connected to the end panels of other like vessels to encompass an area into which the spilled oil can be directed in operation of the endless belt conveyors of the interconnected harvesting vessels.

It is an object of the present invention to provide an improved method and means for harvesting oil slicks.

### SUMMARY OF THE INVENTION

According to a first aspect of the present invention there is provided a method of harvesting an oil slick, which method includes:—
a) providing an oil slick harvesting vessel which has an endless belt conveyor for conveying spilled oil from one side of the vessel to the other and deployable hinged panels which extend along both ends and said other side of the vessel,
b) deploying the hinged panels so that they encompass an area on said other side of the vessel and within which the spilled oil can be collected, and
c) operating the endless belt conveyor to transfer the spilled oil into the encompassed area.

The endless belt conveyor is preferably so arranged that the end thereof at said one side of the vessel is at a lower level than the other end thereof so that, during operation of the endless belt conveyor, spilled oil contacted by the endless belt conveyor will be lifted and transferred into the encompassed area.

Pump means may also be provided for drawing water towards said endless belt conveyor and into the vessel from said one side thereof and discharging it downwardly from the vessel.

The pump means (if provided) and the endless conveyor will thus be operated in such manner that the flow of water into or towards the vessel produces a flow of the spilled oil into contact with the endless belt conveyor for transfer thereof into the encompassed area.

According to a second aspect of the present invention there is provided an oil slick harvesting vessel which has an endless belt conveyor for conveying spilled oil from one side of the vessel to the other, and deployable hinged panels which extend along both ends and said other side of the vessel and which are deployable so that they encompass an area on said other side of the vessel and within which the spilled oil can be collected.

The hinged panels are preferably provided with sealing means in the form of gaskets to stop any egress of oil from the encompassed or circumscribed area.

The hinged panels preferably comprise two hinged panels at each end of the vessel, each of which has a length substantially equal to the width of the vessel. The hinged panels preferably also comprise three hinged panels at said other side of the vessel, each of which has a length substantially equal to the length of the vessel.

Pump means may be provided for drawing water towards and into the vessel from said one side thereof and discharging it downwardly from the vessel, the arrangement being such that, on operating the pump means and the endless conveyor, a flow of water is produced into the vessel so as to produce a flow of the spilled oil into contact with the endless belt conveyor for transfer thereof into the encompassed area.

The discharge outlets of the pump means are preferably located below the vessel and arranged for rotation to provide steerable thrust.

The endless belt conveyor preferably includes a number of parallel flat belts which extend side by side within the vessel and, unlike the conveyor of the harvesting vessel described in British Patent Specification No. 2 310 381, do not include scoops. The arrangement is thus such that the oil is transferred from one side of the vessel to the other, i.e. to the encompassed area, due to the natural viscosity of the oil. The picked up oil is preferably scraped off the endless belts by means of blades or bars, each of which extends for the full width of the associated belt and is located at or adjacent the uppermost end of the belt. An access platform is preferably provided above the vessel.

The harvesting vessel preferably has a length of the order of 10 metres and a width of the order of 5 metres, with two hingedly connected panels at each end of the vessel and pivotally connected to the ends of said other side of the vessel. The free ends of the hingedly connected panels at the ends of the vessel are then pivotally connected to the three hingedly connected panels which each extend for substantially the length of the other side of the vessel.

The panels will preferably have a height (or depth) of the order of 9 metres with the arrangement such that the water line will be about 3 metres below the tops of the panels, giving a depth of about 6 metres below the water line.

The vessel will preferably have a Global Positioning System (GPS) for communication and control purposes and, in an emergency, several vessels will normally be transported to an oil slick by means of helicopters, by ship or by road and placed at strategic points, working independently of each other while maintaining communication with one another.

### BRIEF DESCRIPTION OF THE DRAWINGS

FIG. 1 is a diagrammatic perspective view of an oil slick harvesting vessel with its panels fully deployed,

FIG. 2 is a diagrammatic plan view of the oil slick harvesting vessel of FIG. 1 with its panels fully folded, and

FIGS. 3 and 4 are diagrammatic plan views of the oil slick harvesting vessel if FIG. 1 with its panels partially deployed.

### DESCRIPTION OF THE PREFERRED EMBODIMENT

The vessel 10 shown in the drawings is of rectangular form in plan view and has a length of the order of 10 metres and a width of the order of 5 metres, with two hingedly connected panels 11A and 11B or 12A and 12B at each end of the vessel 10. The panels 11A and 12A are pivotally connected to the ends of one of the sides of the vessel 10 and the panels 11B and 12B are pivotally connected to the ends of the panels 11A and 12A. Each of the panels 11A, 11B, 12A and 12B has a length which is substantially equal to the width of the vessel 10 so that, when the panels 11A, 11B, 12A and 12B are in their compact storage or travelling positions, they are located against the ends of the vessel 10 and extend substantially parallel to the adjacent end of the vessel 10.

The free ends of panels 11B and 12B are then pivotally connected to three hingedly connected panels 13A, 13B and 13C which each extend for substantially the length of a side of the vessel 10. Panel 13A is pivotally connected to panel 11B, panel 13B is pivotally connected to panel 13A and panel 13C is pivotally connected at its one vertical edge to panel 13B and at its other vertical edge to panel 12B. When the panels 13A, 13B, and 13C are in their compact storage or travelling positions, they are located against the side of the vessel 10 and extend substantially parallel to the adjacent side of the vessel 10.

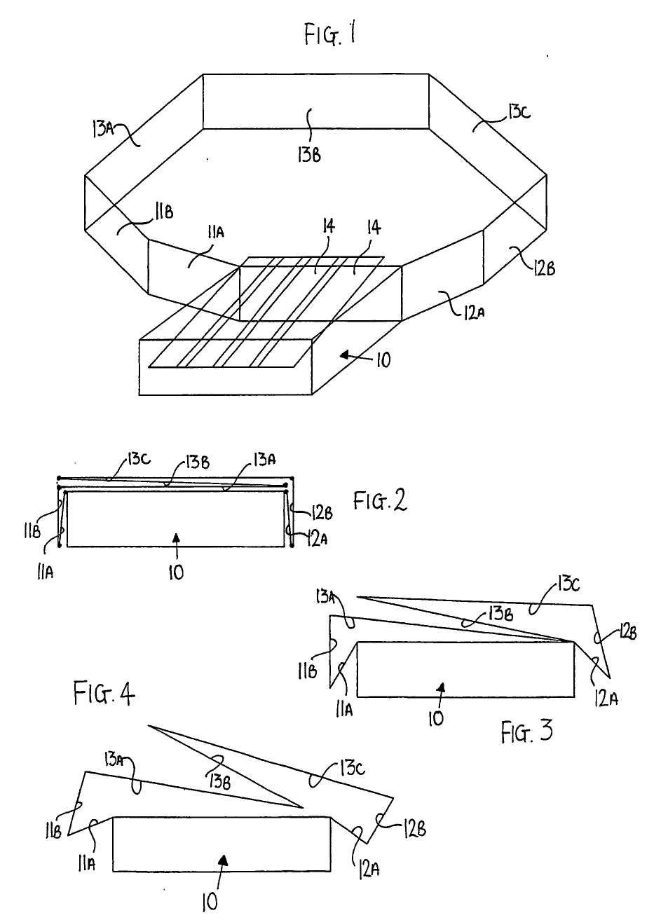

When the vessel 10 reaches a location at which there is an oil slick which requires collection, the panels 11A, 11B, 12A, 12B, 13A, 13B and 13C are moved under the action of hydraulic piston and cylinder mechanisms (not shown) from the positions shown in FIG. 2 into the positions shown in FIG. 3, and then into the positions shown in FIG. 4, and finally into the positions shown in FIG. 1, such movements of the panels being carried out progressively under the control of the piston and cylinder mechanisms such that, when the panels are in the positions shown in FIG. 1, a substantial area is encompassed or circumscribed by the panels and by the side of the vessel 10 to which panels 11A and 12A are pivotally connected. The panels will typically be provided with sealing means in the form of gaskets fitted to the hinged or pivotal connections between adjacent panels and between panels 11A and 12A and the side of the vessel 10.

A series of endless belt conveyors 14 are mounted on the vessel 10, with the belts of the conveyors 14 extending parallel to one another from side to side of the vessel 10. The belts of the conveyors 14 are inclined to the horizontal with the lower ends of the conveyor runs on the side of the vessel 10 remote from the area encompassed by the panels. During operation of the conveyors 14, the oil which comes into contact with the belts of the conveyors 14 is transferred from the side of the vessel 10 remote from the encompassed area to the other side of the vessel 10 due to the natural viscosity of oil. The picked up oil is scraped off the endless belts by means of a series of blades or bars, each of which extends for the full width of the associated belt and is located at or adjacent the uppermost end of the associated belt.

The belts of the conveyors 14 are designed so that the seaward side of each belt adjusts so that the bottom of the belt has maximum contact with the oil as, if the conveyor belts are immersed too deeply into the water, they tend to convey only a small amount of water mixed with oil. Even though a certain amount of water is picked up by the conveyor belts, when the mixture of oil and water is deposited into the encompassed area, it will tend to travel downwardly through the oil, mixing with the water below.

Pumps (not shown) can be provided for drawing water towards and into the vessel 10 from the side thereof remote from the deployed panels and discharging it downwardly from the vessels, the arrangement being such that, on operating the pumps and the endless conveyors 14, a flow of water is produced into the vessel 10 so as to produce a flow of the spilled oil into contact with the endless belt conveyors 14 for transfer thereof into the encompassed area. The oil slick is encouraged by the pumps to remain in contact with the conveyor belts.

The discharge outlets of the pumps will be located below the vessel 10 and arranged for rotation to provide steerable thrust to facilitate suitable positioning of the vessel 10.

The harvesting vessel 10 typically has a length of the order of 10 metres and a width of the order of 5 metres, while the panels 11A, 11B, 12A, 12B, 13A, 13B and 13C will typically have a height (or depth) of the order of 9 metres with the arrangement such that the water line will be about 3 metres below the tops of the panels, giving a depth of about 6 metres below the water line. To enable the vessel to sit two thirds below the water line and, at the same time, to be as light as possible for transport purposes, the majority of the required ballast will be provided by allowing water to flood tanks within the vessel. The hingedly connected panels will have buoyancy for the top third, while the outer skin of each panel facing away from the encompassed or confined area will be perforated with holes allowing water to fill the void and act as ballast.

If harvesting a volatile mixture, such that there is a high risk of explosion either through the production of an inflammable vapour by evaporation or as a result of the mixture itself being of a highly inflammable nature, a foam barrier containing a fire preventative agent is preferably sprayed onto the surface within the encompassed area. The foam barrier will have a composition such that it floats on the surface of the harvested oil. The oil and water mix will have a density greater than that of the foam barrier so that the oil and mixture conveyed into the encompassed area will travel downwardly through the fire barrier. The mixture will then separate allowing the oil to build up below the fire barrier while the water will sink to below the layer of oil.

Harvesting of the oil slick will be continued such that the oil within the encompassed area will build up to a level approaching the full depth of the vessel 10, at which time a conventional tanker can be used to surface pump the collected and separated oil from within the encompassed area. With a vessel having end and side panels of the size described above, the encompassed area will be of sufficient size to enable 1 million litres of oil to be harvested. Most of the harvested oil will have been unaffected by the recovery process and can, therefore, be recycled.

1. A method of harvesting an oil slick, which method includes:—
a) providing an oil slick harvesting vessel which has an endless belt conveyor for conveying spilled oil from one side of the vessel to the other and deployable hinged panels which extend along both ends and said other side of the vessel,
b) deploying the hinged panels so that they encompass an area on said other side of the vessel and within which the spilled oil can be collected, and
c) operating the endless belt conveyor to transfer the spilled oil into the encompassed area.

2. A method as claimed in claim 1, in which the endless belt conveyor is so arranged that the end thereof at said one side of the vessel is at a lower level than the other end thereof so that, during operation of the endless belt conveyor, spilled oil contacted by the endless belt conveyor will be lifted and transferred into the encompassed area.

3. A method as claimed in claim 1, in which pump means are provided for drawing water towards said endless belt conveyor and into the vessel from said one side thereof and discharging it downwardly from the vessel.

4. A method as claimed in claim 3, in which the pump means and the endless conveyor are operated in such manner that the flow of water into or towards the vessel produces a flow of the spilled oil into contact with the endless belt conveyor for transfer thereof into the encompassed area.

5. An oil slick harvesting vessel which has an endless belt conveyor for conveying spilled oil from one side of the vessel to the other, and deployable hinged panels which extend along both ends and said other side of the vessel and which are deployable so that they encompass an area on said other side of the vessel and within which the spilled oil can be collected.

6. An oil slick harvesting vessel as claimed in claim 5, in which the hinged panels are provided with sealing means in the form of gaskets to stop any egress of oil from the encompassed or circumscribed area.

7. An oil slick harvesting vessel as claimed in claim 5, in which the hinged panels comprise two hinged panels at each end of the vessel, each of which has a length substantially equal to the width of the vessel.

8. An oil slick harvesting vessel as claimed in claim 7, in which the hinged panels also comprise three hinged panels at said other side of the vessel, each of which has a length substantially equal to the length of the vessel.

9. An oil slick harvesting vessel as claimed in claim 5, in which pump means are provided for drawing water towards and into the vessel from said one side thereof and discharging it downwardly from the vessel, the arrangement being such that, on operating the pump means and the endless conveyor, a flow of water is produced into the vessel so as to produce a flow of the spilled oil into contact with the endless belt conveyor for transfer thereof into the encompassed area.

10. An oil slick harvesting vessel as claimed in claim 9, in which the discharge outlets of the pump means are located below the vessel and are arranged for rotation to provide steerable thrust.

11. An oil slick harvesting vessel as claimed in claim 5, in which the endless belt conveyor includes a number of parallel flat belts which extend side by side within the vessel.

12. An oil slick harvesting vessel as claimed in claim 8, which has a length of the order of 10 metres and a width of the order of 5 metres, with two hingedly connected panels at each end of the vessel and pivotally connected to the ends of said other side of the vessel.

13. An oil slick harvesting vessel as claimed in claim 12, in which the free ends of the hingedly connected panels at the ends of the vessel are pivotally connected to the three hingedly connected panels which each extend for substantially the length of the other side of the vessel, and in which the panels have a height (or depth) of the order of 9 metres with the arrangement such that the water line will be about 3 metres below the tops of the panels, giving a depth of about 6 metres below the water line.
